(19) United States
(12) Patent Application Publication
(10) Pub. No.: US 2026/0257657 A1
(43) Pub. Date: Sep. 3, 2026

(54) ACTUATION DEVICE FOR A BRAKE SYSTEM, METHOD FOR PRODUCING AN ACTUATION DEVICE FOR A BRAKE SYSTEM

(71) Applicant: Robert Bosch GmbH, Stuttgart (DE)

(72) Inventors: Alice Schacherl, Burgberg (DE); Ben Ferguson, Rettenberg (DE); Bernd Lutz, Kempten (DE); Christoph Voelkel, Waltenhofen (DE); Guenter Escher, Oberstdorf (DE); Ignaz Hatt, Buchenberg (DE); Martin Winkler, Sonthofen (DE); Sven Langhorst, Kempten (DE)

(21) Appl. No.: 18/866,256

(22) PCT Filed: May 25, 2023
(86) PCT No.: PCT/EP2023/064052

§ 371 Date: Nov. 15, 2024

(30) Foreign Application Priority Data
May 30, 2022 (DE) 10 2022 205 437.7

(51) Int. Cl. B60T 13/74; F16H 25/24

(52) U.S. Cl. CPC B60T 13/745; F16H 25/2454

(57) ABSTRACT

An actuation device for a brake system which has an actuatable master brake cylinder. The actuation device includes a gearing device which has a displaceable threaded spindle, wherein the master brake cylinder can be actuated by displacing the threaded spindle, an electric motor for driving the gearing device, and a housing in which the threaded spindle is at least partially arranged, wherein a rotation-locking element is connected to the threaded spindle against rotation, and wherein the housing has at least one rotational counter-stop which interacts with a rotational stop of the rotation-locking element in order to form an anti-rotation device for the threaded spindle. The housing is an extrusion profile, and the rotational counter-stop is formed by an extrusion structure of the extrusion profile.

### FIELD

The present invention relates to an actuation device for a brake system which has an actuatable master brake cylinder, comprising a gearing device which has a displaceable threaded spindle, wherein the master brake cylinder can be actuated by displacing the threaded spindle, an electric motor for driving the gearing device, and a housing in which the threaded spindle is at least partially arranged, wherein a rotation-locking element is connected to the threaded spindle against rotation, and wherein the housing has at least one rotational counter-stop which interacts with a rotational stop of the rotation-locking element in order to form an anti-rotation device for the threaded spindle.

The present invention also relates to a method for producing an actuation device for a brake system, wherein a housing with at least one rotational counter-stop and a gearing device with a displaceable threaded spindle are provided, wherein a rotation-locking element is connected to the threaded spindle against rotation, wherein the gearing device is arranged in such a way that the threaded spindle is at least partially arranged in the housing and a rotational stop of the rotation-locking element interacts with the rotational counter-stop of the housing in order to form an anti-rotation device for the threaded spindle, and wherein an electric motor is operatively connected to the gearing device in such a way that the gearing device can be driven by the electric motor.

### BACKGROUND INFORMATION

A hydraulic brake system of a motor vehicle typically has a plurality of friction brake devices, which are hydraulically connected to a master brake cylinder of the brake system. When the master brake cylinder is actuated, hydraulic fluid is displaced into slave cylinders of the friction brake devices, so that the friction brake devices then generate a friction braking torque. For actuating the master brake cylinder, an actuation device is typically present. With the increasing electrification of motor vehicles, actuation devices of brake systems are also becoming increasingly electrified. An actuation device of the type mentioned at the outset is described, for example, in German Patent Application No. DE 10 2020 208 764 A1. The actuation device has a gearing device with a displaceable threaded spindle. The gearing device can be driven by an electric motor of the actuation device. If the actuation device is installed in the brake system as intended, the master brake cylinder can be actuated by displacing the threaded spindle. The actuation device also has a housing with at least one rotational counter-stop. The threaded spindle is at least partially arranged in the housing. In order to prevent rotation of the threaded spindle relative to the housing, a rotation-locking element connected to the threaded spindle against rotation is present. The rotational counter-stop of the housing interacts with a rotational stop of the rotation-locking element in order to form an anti-rotation device for the threaded spindle.

### SUMMARY

In an actuation device according to the present invention, the housing is an extrusion profile, and the rotational counter-stop is formed by an extrusion structure of the extrusion profile. An extrusion profile is a component manufactured by extrusion. An extrusion profile has the same cross-sectional area along its entire longitudinal extent, apart from any post-processing carried out on the extrusion profile. The cross-sectional area of an extrusion profile corresponds in terms of its shape to the opening of the extrusion tool used to produce the extrusion profile. Extrusion profiles are typically cost-effective to produce, so that the production costs for the actuation device can be reduced by designing the housing as an extrusion profile. An extrusion structure is a structure of the extrusion profile that is manufactured by extrusion. By extrusion, suitable structures for forming the rotational counter-stop can be realized in a simple manner. Since the rotational counter-stop is formed by an extrusion structure, complex post-processing for forming the rotational counter-stop is not necessary. This has the result that the costs for producing the actuation device can be further reduced. Particularly preferably, the housing, or the extrusion profile, is made of aluminum. According to the present invention, the threaded spindle is at least partially arranged in the housing or the extrusion profile. Preferably, the threaded spindle extends into the housing, so that the threaded spindle is only partially arranged in the housing. Alternatively, the threaded spindle is entirely arranged in the extrusion profile. The housing is preferably tubular and thus has a circumferential casing wall, which defines, or encloses, a housing interior of the housing. The rotation-locking element is preferably formed separately from the threaded spindle and fastened to the threaded spindle. Alternatively, the rotation-locking element is preferably formed in one piece with the threaded spindle.

Preferably, the rotation-locking element is arranged at an end of the threaded spindle that faces the master brake cylinder.

According to a preferred embodiment of the present invention, a displacement axis of the threaded spindle is aligned perpendicularly to the cross-sectional area of the extrusion profile. As a result, the operative connection between the threaded spindle and the master brake cylinder can be realized in a simple manner. Preferably, the master brake cylinder is arranged on an end face of the extrusion profile.

According to a preferred embodiment of the present invention, the gearing device has a spindle gear, wherein the spindle gear has the threaded spindle and a rotatably mounted spindle nut, wherein the spindle nut is rotatable in a first direction of rotation and in a second direction of rotation opposite to the first direction of rotation, and wherein the anti-rotation device is designed to block rotation of the threaded spindle both in the first direction of rotation and in the second direction of rotation. Such a design of the anti-rotation device ensures that, by rotating the spindle nut, the threaded spindle can be displaced, depending on the direction of rotation of the spindle nut, along the displacement axis both in a first direction and in a second direction opposite to the first direction.

According to an example embodiment of the present invention, preferably, the extrusion profile has at least one first rotational counter-stop aligned opposite to the first direction of rotation and at least one second rotational counter-stop aligned opposite to the second direction of rotation, wherein the first rotational counter-stop interacts with a first rotational stop of the rotation-locking element, and wherein the second rotational counter-stop interacts with a second rotational stop of the rotation-locking element. Preferably, the first rotational counter-stop and the second rotational counter-stop are part of the same extrusion structure of the extrusion profile. Alternatively, the first rotational counter-stop and the second rotational counter-stop are preferably part of different extrusion structures of the extrusion profile. Preferably, the extrusion profile has a plurality of first rotational counter-stops spaced apart from one another in the circumferential direction of the extrusion profile and/or a plurality of second rotational counter-stops spaced apart from one another in the circumferential direction of the extrusion profile.

According to a preferred embodiment of the present invention, the extrusion structure is a groove extending through the extrusion profile, and a radial protrusion of the rotation-locking element engages radially in the groove. On the one hand, a groove extending through the extrusion profile can be realized in a technically simple manner by extrusion. In addition, a groove is particularly suitable for forming the anti-rotation device. The aforementioned first rotational counter-stop and the aforementioned second rotational counter-stop are preferably formed by different side walls of the groove. Preferably, the groove extends through the extrusion profile axially in relation to the displacement axis of the threaded spindle.

Preferably, according to an example embodiment of the present invention, the extrusion profile has a plurality of grooves which extend through the extrusion profile and are spaced apart from one another in the circumferential direction of the extrusion profile. Particularly preferably, there are two grooves, which are diametrically opposite each other.

Preferably, according to an example embodiment of the present invention, the rotational counter-stop has a sliding coating. Low-friction guidance of the rotation-locking element and thus of the threaded spindle in the extrusion profile can be achieved by means of the sliding coating. For example, the sliding coating is a coating made of a plastics material, in particular PTFE.

According to a preferred embodiment of the present invention, the rotation-locking element has a sliding shoe, and the sliding shoe forms the rotational stop. Low-friction guidance of the rotation-locking element and thus of the threaded spindle in the extrusion profile can also be achieved by means of the sliding shoe. The sliding shoe is preferably made of plastics material. If the rotation-locking element has the sliding shoe, the aforementioned sliding coating is preferably omitted.

Preferably, according to an example embodiment of the present invention, the actuation device has a pressure force transmitter displaceably mounted in an opening of the threaded spindle, wherein the pressure force transmitter is connected to an input rod of the actuation device, and wherein the master brake cylinder can be actuated by displacing the pressure force transmitter. The master brake cylinder can thus be actuated both by means of the threaded spindle by the electric motor and by means of the pressure force transmitter by the input rod. By mounting the pressure force transmitter in the opening of the threaded spindle, a particularly advantageous connection of both the pressure force transmitter and the threaded spindle to the master brake cylinder can be achieved. In particular, both the threaded spindle and the pressure force transmitter are arranged or aligned coaxially with hydraulic pistons displaceably mounted in the master brake cylinder.

According to a preferred embodiment of the present invention, a casing wall of the extrusion profile has a flat first mounting surface, and a control unit of the actuation device is arranged on the first mounting surface. Since the first mounting surface is flat, it is particularly suitable for the arrangement of a control unit. In addition, flat mounting surfaces can be realized in a simple manner by extrusion. Preferably, the control unit is designed to control the electric motor.

According to a preferred embodiment of the present invention, the casing wall has a flat second mounting surface, and the electric motor is arranged on the second mounting surface. Since the second mounting surface is flat, it is particularly suitable for the arrangement of the electric motor. In addition, flat mounting surfaces can be realized in a simple manner by extrusion.

Preferably, according to an example embodiment of the present invention, the casing wall has at least one opening. Preferably, the opening is formed by post-processing the extrusion profile. For example, the opening is milled into the casing wall. The opening of the casing wall in the actuation device can fulfill various tasks. Preferably, the casing wall has an opening into which a sensor is inserted, which is designed to monitor the sliding positions of the threaded spindle and of the pressure force transmitter. Alternatively or additionally, the casing wall preferably has at least one opening through which a gear shaft of the gearing device is rotatably mounted. Alternatively or additionally, the casing wall preferably has at least one opening through which at least one electrically conductive motor phase supply line extends.

In a method according to an example embodiment the present invention, the housing together with the rotational counter-stop is manufactured by extrusion. This also results in the advantages already mentioned. Further preferred features and combinations of features result from what was described above and is the rest of the disclosure herein.

The present invention is explained in more detail below with reference to the figures.

### BRIEF DESCRIPTION OF THE DRAWINGS

FIG. 1 is a perspective view of an actuation device for a brake system, according to an example embodiment of the present invention.

FIG. 2 is a sectional view of the actuation device, according to an example embodiment of the present invention.

FIG. 3 shows a housing of the actuation device, according to an example embodiment of the present invention.

FIG. 4 is a further view of the housing, according to an example embodiment of the present invention.

FIG. 5 shows a method for producing the actuation device, according to an example embodiment of the present invention.

### DETAILED DESCRIPTION OF EXAMPLE EMBODIMENTS

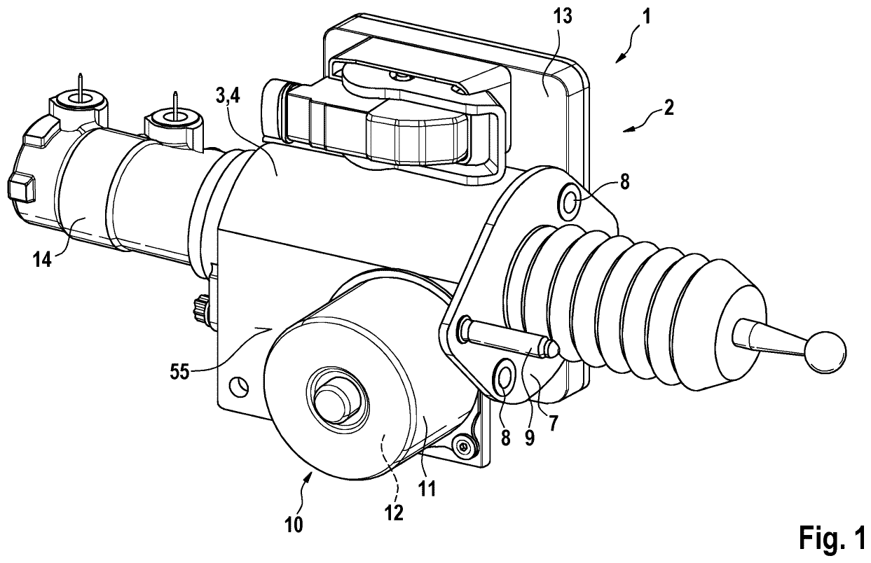

FIG. 1 is a perspective view of an actuation device 1 for a brake system 2 (not shown in detail) of a motor vehicle. The actuation device 1 has a housing 3. The housing 3 is tubular and thus has a circumferential casing wall 4, which encloses a housing interior 5 of the housing 3. A disk-shaped housing part 7 is arranged on an end face 6 of the housing 3. In the present case, the housing part 7 is fastened to the housing 3 by a plurality of fastening means 8. The housing part 7 has a plurality of fastening structures 9 for fastening the actuation device 1 to a body of the motor vehicle.

The actuation device 1 also has a drive assembly 10, which is arranged on the housing 3. The drive assembly 10 has an electric motor 12, which is arranged in a motor housing 11 and is therefore not visible in FIG. 1. The actuation device 1 also has a control unit 13. The control unit 13 is arranged on the housing 3 on a side of the housing 3 that faces away from the drive assembly 10. The control unit 13 is designed to control the electric motor 12. On a further end face of the housing 3 that faces away from the end face 6, a master brake cylinder 14 is arranged, in which two hydraulic pistons 15 are displaceably mounted in the present case. If the actuation device 1 is installed in the brake system 2 as intended, the master brake cylinder 14 is fluidically connected to slave cylinders of friction brake devices of the brake system 2.

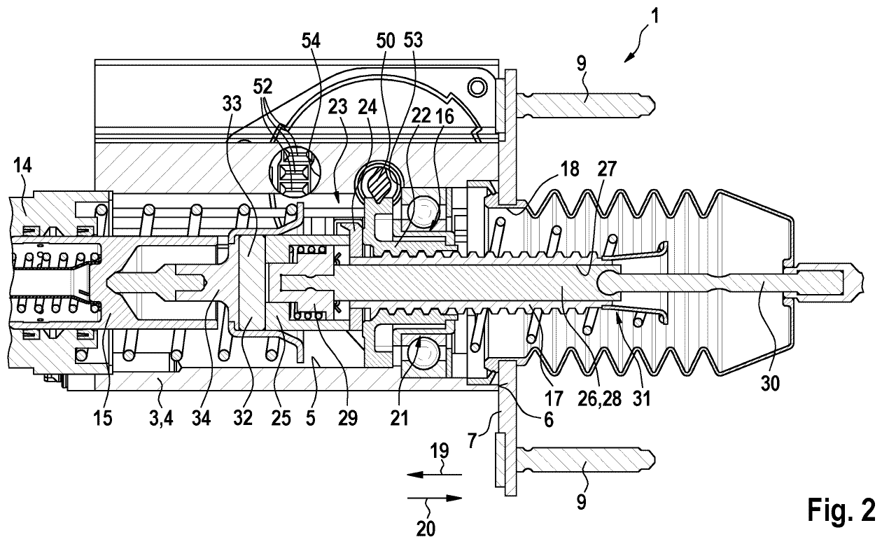

FIG. 2 is a longitudinal section of the actuation device 1. The actuation device 1 has a gearing device 16. The gearing device 16 is operatively connected to the electric motor 12 in such a way that the gearing device 16 can be driven by the electric motor 12. The gearing device 16 has a displaceably mounted threaded spindle 17. The threaded spindle 17 extends through an opening 18 of the housing part 7 into the housing interior 5 of the housing 3 and is thus partially arranged in the housing interior 5 of the housing 3. The threaded spindle 17 is displaceable along a displacement axis in a first direction 19 and in a second direction 20 opposite to the first direction 19. The directions 19 and 20 are aligned perpendicularly to the cross-sectional area of the housing 3. The threaded spindle 17 is part of a spindle gear 21 of the gearing device 16. In addition to the threaded spindle 17, the spindle gear 21 has a rotatably mounted spindle nut 22. The spindle nut 22 is rotatable in a first direction of rotation 42 and in a second direction of rotation 43 opposite to the first direction of rotation 42. An internal toothing of the spindle nut 22 meshes with an external toothing of the threaded spindle 17. In order to ensure that, when the spindle nut 22 rotates, the threaded spindle 17 is displaced rather than rotates with the spindle nut 22, the threaded spindle 17 is assigned an anti-rotation device 23. For this purpose, a rotation-locking element 24 is provided, which is fastened to the threaded spindle 17, in the present case to an end of the threaded spindle 17 that faces the master brake cylinder 14. According to a further exemplary embodiment, the rotation-locking element 24 is formed in one piece with the threaded spindle 17. The rotation-locking element 24 interacts with the housing 3 in order to form the anti-rotation device 23, as explained in more detail below. In the present case, a pot-shaped push body 25 is fastened to the rotation-locking element 24.

The actuation device 1 also has a pressure force transmitter 26 mounted displaceably relative to the threaded spindle 17, wherein the pressure force transmitter 26 also extends through the opening 18 into the housing interior 5 and is thus partially arranged in the housing interior 5 of the housing 3. The pressure force transmitter 26 is displaceable in the first direction 19 and in the second direction 20. In the present case, the pressure force transmitter 26 is mounted in an opening 27 of the threaded spindle 17. According to the exemplary embodiment shown in FIG. 2, the pressure force transmitter 26 is designed in multiple parts. For this purpose, the pressure force transmitter 26 has a rod-shaped portion 28, which is arranged in the opening 27. In addition, the pressure force transmitter 26 has a pressure cap 29, which is arranged at an end of the pressure force transmitter 26 that faces the master brake cylinder 14. The pressure cap 29 is fastened to the rod-shaped portion 28, in the present case by crimping. An end of the pressure force transmitter 26 that faces away from the master brake cylinder 14 is connected to an input rod 30, so that the pressure force transmitter 26 can be displaced by the input rod 30. In the present case, the pressure force transmitter 26 is connected to the input rod 30 by a ball joint 31. An end of the input rod 30 that faces away from the pressure force transmitter 26 is fastened to a brake pedal (not shown).

The master brake cylinder 14 can be actuated both by displacing the threaded spindle 17 and by displacing the pressure force transmitter 26. Actuation of the master brake cylinder 14 is understood to mean that the hydraulic pistons 15 are displaced in the first direction 19. If the actuation device 1 is installed in the brake system 2 as intended, a hydraulic fluid is thereby displaced from the master brake cylinder 14 into the slave cylinders of the friction brake devices, so that the friction brake devices then generate a friction braking torque. In the present case, the threaded spindle 17 and the pressure force transmitter 26 are operatively connectable or connected to the hydraulic pistons 15 by a coupling element 32. The coupling element 32 has an elastically deformable coupling disk 33 and a rigid pressure rod 34. If the master brake cylinder 14 is actuated by the electric motor 12, the electric motor 12 acts on the hydraulic pistons 15 by means of the threaded spindle 17, the rotation-locking element 24, the push body 25, and the coupling element 32. If the master brake cylinder 14 is actuated by actuating the brake pedal, the brake pedal acts on the hydraulic pistons 15 by means of the input rod 30, the pressure force transmitter 26, and the coupling element 32.

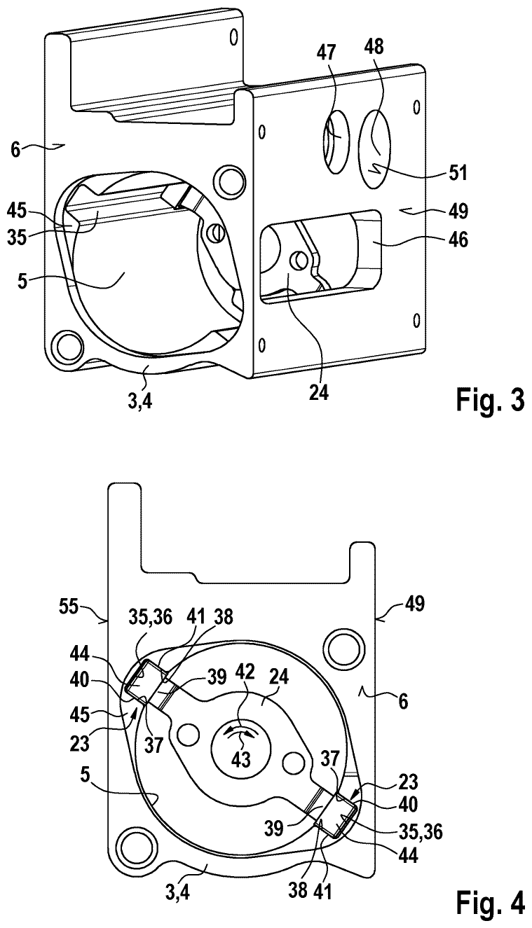

The structure of the housing 3 is explained in more detail below with reference to FIGS. 3 and 4. FIG. 3 is a perspective view of the housing 3. FIG. 4 is a view of the housing 3 in which the viewing direction corresponds to the first direction 19. The housing 3 is an extrusion profile 3. This means that the housing 3 is manufactured by extrusion. A component manufactured by extrusion has the same cross-sectional area at every point along its longitudinal extent, apart from any post-processing carried out on the component. In the present case, the housing 3, or the extrusion profile 3, is made of aluminum. As can be seen in the figures, the housing interior 5 has a circular cross-section in the present case.

As mentioned above, the rotation-locking element 24 interacts with the housing 3 in order to form the anti-rotation device 23. For this purpose, the housing 3 has a plurality of grooves 35, which extend in the housing interior 5 through the casing wall 4 of the housing 3. In the present case, there are two grooves 35, which are diametrically opposite each other. The grooves 35 are aligned perpendicularly to the cross-sectional area of the housing 3 and thus extend in the axial direction in relation to the displacement axis of the threaded spindle 17. The grooves 35 are each formed by a bottom 36, a first rotational counter-stop 37, and a second rotational counter-stop 38, wherein the rotational counter-stops 37, 38 are opposite one another. The first rotational counter-stops 37 are aligned opposite to the first direction of rotation 42 of the spindle nut 22. The second rotational counter-stops 38 are aligned opposite to the second direction of rotation 43 of the spindle nut 22. In the present case, the rotational counter-stops 37, 38 are aligned perpendicularly to the bottom 36. Alternatively, the rotational counter-stops 37, 38 are aligned obliquely to the bottom 36. For example, an angle between the bottom and the rotational counter-stops 37, 38 is 60° in each case. The grooves 35 are extrusion structures 35 of the extrusion profile 3. This means that the grooves 35 are manufactured by extrusion. The grooves 35 are thus already visible in an opening of the extrusion tool that was used to produce the extrusion profile 3. The rotation-locking element 24 has a number of radial protrusions 39 corresponding to the number of grooves 35. Each of the radial protrusions 39 engages radially in each case into a different one of the grooves 35 in order to form the anti-rotation device 23. The radial protrusions 39 each have a first rotational stop 40 and a second rotational stop 41. The first rotational stops 40 are located opposite the first rotational counter-stops 37 of the grooves 35. The second rotational stops 41 are located opposite the second rotational counter-stops 38 of the grooves 35.

If the rotation-locking element 24 and thus the threaded spindle 17 are subjected by the spindle nut 22 to a torque acting in the first direction of rotation 42, the first rotational stops 40 of the radial protrusions 39 come into contact with the first rotational counter-stops 37 of the grooves 35. This blocks the rotation of the rotation-locking element 24 and thus of the threaded spindle 17 in the first direction of rotation 42. If the rotation-locking element 24 and thus the threaded spindle 17 are subjected by the spindle nut 22 to a torque acting in the second direction of rotation 43, the second rotational stops 41 of the radial protrusions 39 come into contact with the second rotational counter-stops 38 of the grooves 35. This blocks the rotation of the rotation-locking element 24 and thus of the threaded spindle 17 in the second direction of rotation 43. The rotational stops 40, 41 of the rotation-locking element 24 thus interact with the rotational counter-stops 37, 38 of the extrusion profile 3 in order to form the anti-rotation device 23.

According to the exemplary embodiment shown in the figures, the radial protrusions 39 each have a sliding shoe 44 made of plastics material, wherein the sliding shoes 44 form the rotational stops 40, 41. The sliding shoes 44 made of plastics material ensure low-friction guidance of the rotation-locking element 24 in the grooves 35. According to a further exemplary embodiment, the grooves 35 have a sliding coating at least in the region of the rotational counter-stops 37, 38. Low-friction guidance of the rotation-locking element 24 in the grooves 35 can also be ensured by providing a sliding coating. If the sliding coating is present, the sliding shoes 44 are in particular omitted.

As can be seen in the figures, the extrusion profile 3, or the housing 3, also has a plurality of structures that are not manufactured by extrusion, but by post-processing the extrusion profile 3. For example, the housing 3 has a housing step 45 milled into the casing wall 4. In addition, the casing wall 5 has a plurality of openings 46, 47, 48, which are formed in the region of a first mounting surface 49 of the casing wall 4. When the actuation device 1 is assembled as intended, the control unit 13 is arranged on the first mounting surface 49. A first opening 46 of the openings 46, 47, 48 is rectangular. If the actuation device 1 is assembled as intended, a sensor, which is designed to monitor the sliding positions of the threaded spindle 17 and of the pressure force transmitter 26, is arranged in the first opening 46. A second opening 47 of the openings 46, 47, 48 is circular. If the actuation device 1 is assembled as intended, a gear shaft 50 of the gearing device 17, which is designed as a worm shaft 50 in the present case, extends from the housing interior 6 into the opening 47 or through the opening 47. In particular, the gear shaft 50 is rotatably mounted by a bearing surface 51 delimiting the second opening 47. For example, a pivot bearing that acts between the gear shaft 50 and the bearing surface 51 is present. A third opening 48 of the openings 46, 47, 48 is also circular. If the actuation device 1 is assembled as intended, a plurality of electrically conductive motor phase supply lines 52 extend through the third opening 48 into the housing interior 5. As can be seen in FIG. 2, the extrusion profile 3, or the housing 3, also has a fourth opening 53 and a fifth opening 54. The openings 53 and 54 are formed in the region of a second mounting surface 55 of the casing wall 4. When the actuation device 1 is assembled as intended, the electric motor 12 or the drive assembly 10 is arranged on the second mounting surface 55. The fourth opening 53 is aligned with the second opening 47. The gear shaft 50 extends through the fourth opening 53 from the housing interior 5 into the motor housing 11. In the present case, the gear shaft 50 thus extends through the housing 3. The fifth opening 54 is aligned with the third opening 48. The motor phase supply lines 52 extend through the fifth opening 54 into the motor housing 11. The motor phase supply lines 52 thus also extend through the housing 3. The motor phase supply lines 52 are electrically connected to a motor winding of the electric motor 12 on the one hand and to the control unit 13 on the other hand.

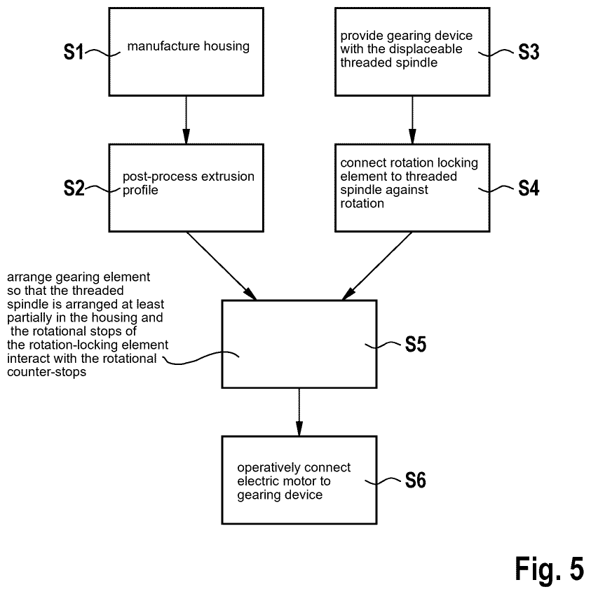

FIG. 5 shows a method for producing the actuation device 1 using a flow chart.

In a first step S1, the housing 3 is manufactured. The housing 3 together with the rotational counter-stops 37, 38 is manufactured by extrusion. The housing 3 is thus obtained as an extrusion profile 3, as mentioned above. The rotational counter-stops 37, 38 are formed by extrusion structures 35 of the extrusion profile 3, in the present case by the grooves 35. In a second step S2, the extrusion profile 3 is post-processed. For example, the structures 45, 46, 47, 48, 53, 54 are milled into the extrusion profile 3. In a third step S3, the gearing device 16 with the displaceable threaded spindle 17 is provided. In a fourth step S4, the rotation-locking element 24 is connected to the threaded spindle 17 against rotation. According to a further exemplary embodiment, the rotation-locking element 24 is manufactured in one piece with the threaded spindle 17. The threaded spindle 17 together with the rotation-locking element 24 is then installed into the gearing device 16. In a fifth step S5, the gearing device 16 is arranged in such a way that the threaded spindle 17 is at least partially arranged in the housing 3 and the rotational stops 40, 41 of the rotation-locking element 24 interact with the rotational counter-stops 37, 38 of the extrusion profile 3 in order to form the anti-rotation device 23. In a sixth step S6, the electric motor 12 is operatively connected to the gearing device 16 in such a way that the gearing device 16 can be driven by the electric motor 12.

1-13. (canceled)

14. An actuation device for a brake system which has an actuatable master brake cylinder, comprising:
a gearing device which has a displaceable threaded spindle, wherein the master brake cylinder can be actuated by displacing the threaded spindle;
an electric motor configured to drive the gearing device; and
a housing in which the threaded spindle is at least partially arranged;
wherein a rotation-locking element is connected to the threaded spindle against rotation, wherein the housing has at least one rotational counter-stop which interacts with a rotational stop of the rotation-locking element to form an anti-rotation device for the threaded spindle, and wherein the housing is an extrusion profile, and the rotational counter-stop is formed by an extrusion structure of the extrusion profile.

15. The actuation device according to claim 14, wherein a displacement axis of the threaded spindle is aligned perpendicularly to a cross-sectional area of the extrusion profile.

16. The actuation device according to claim 14, wherein the gearing device has a spindle gear, wherein the spindle gear has the threaded spindle and a rotatably mounted spindle nut, wherein the spindle nut is rotatable in a first direction of rotation and in a second direction of rotation opposite to the first direction of rotation, and wherein the anti-rotation device is configured to block rotation of the threaded spindle both in a first direction of rotation and in a second direction of rotation.

17. The actuation device according to claim 16, wherein the extrusion profile has at least one first rotational counter-stop aligned opposite to the first direction of rotation and at least one second rotational counter-stop aligned opposite to the second direction of rotation, wherein the first rotational counter-stop interacts with a first rotational stop of the rotation-locking element, and wherein the second rotational counter-stop interacts with a second rotational stop of the rotation-locking element.

18. The actuation device according to claim 14, wherein the extrusion structure is a groove extending through the extrusion profile, and a radial protrusion of the rotation-locking element engages radially in the groove.

19. The actuation device according to claim 18, wherein the extrusion profile has at least two grooves, which are spaced apart from one another in a circumferential direction of the extrusion profile.

20. The actuation device according to claim 14, wherein the rotational stop has a sliding coating.

21. The actuation device according to claim 14, wherein the rotation-locking element has a sliding shoe, and the sliding shoe forms the rotational stop.

22. The actuation device according to claim 14, wherein a pressure force transmitter is displaceably mounted in an opening of the threaded spindle, wherein the pressure force transmitter is connected to an input rod of the actuation device, and wherein the master brake cylinder can be actuated by displacing the pressure force transmitter.

23. The actuation device according to claim 14, wherein a casing wall of the extrusion profile has a flat first mounting surface, and a control unit of the actuation device is arranged on the first mounting surface.

24. The actuation device according to claim 23, wherein the casing wall has a flat second mounting surface, and the electric motor is arranged on the second mounting surface.

25. The actuation device according to claim 23, wherein the casing wall has at least one opening.

26. A method for producing an actuation device for a brake system, the method comprising the following steps:
providing a housing with at least one rotational counter-stop and a gearing device with a displaceable threaded spindle;
connecting a rotation-locking element to the threaded spindle against rotation;
arranging the gearing device in such a way that the threaded spindle is at least partially arranged in the housing and a rotational stop of the rotation-locking element interacts with the rotational counter-stop of the housing to form an anti-rotation device for the threaded spindle; and
operatively connection an electric motor to the gearing device in such a way that the gearing device can be driven by the electric motor;
wherein the housing together with the rotational counter-stop is manufactured by extrusion.
